(19) United States
(12) Patent Application Publication
(10) Pub. No.: US 2014/0237909 A1
(43) Pub. Date: Aug. 28, 2014

(54) Method and Arrangement Relating to Antenna Mast of Wireless Communication System

(71) Applicant: Arvind Kumar Gupta, Stockholm (SE)

(72) Inventor: Arvind Kumar Gupta, Stockholm (SE)

(73) Assignee: TELEFONAKTIEBOLAGET LM ERICSSON (PUBL), Stockholm (SE)

(21) Appl. No.: 13/322,847

(22) PCT Filed: Nov. 18, 2011
(86) PCT No.: PCT/SE11/51388

§ 371 Date: Nov. 28, 2011

(51) Int. Cl. H01Q 1/12

(52) U.S. Cl. CPC H01Q 1/1242
USPC 52/40; 52/745.17

(57) ABSTRACT

An antenna mast (2) for supporting at least one antenna of a wireless communication system is provided. The antenna mast (2) comprises a base section (4) with a bottom end (10) and a upper end (12), and a first elongated section (6). The base section (4) has a wider first cross section at the bottom end (10) than a second cross section at the upper end (12). The base section (4) comprises a substantially horizontal top end (14). The base section (4) comprises an outer shell assembled from sheet metal steel plates. The first elongated section (6) comprises an outer shell assembled from sheet metal steel plates. The first elongated section (6) is attached to the top end (14) of the base section (4) with an open inner connection between the base section (4) and the first elongated section (6). There is further provided a method of producing an antenna mast (2) for a wireless communication system.

### TECHNICAL FIELD

The technical field relates to antenna masts for supporting at least one antenna of a wireless communication system and to a method of producing an antenna mast for a wireless communication system.

### BACKGROUND

Antenna masts of wireless communication systems are commonly of the steel lattice type. Manufacturing steel lattice masts requires skilled craftsmen and takes place at specialized manufacturing facilities. Furthermore, a lattice mast requires a separate housing for equipment or the wireless communication system at its base.

A different type of antenna mast for a wireless communication system is manufactured from a fibre composite material. One such antenna mast is known under the name: Ericsson Capsule Site. Such an antenna mast is a closed structure and is adapted to house equipment of the wireless communication system inside the mast at its base. The manufacturing of an antenna mast from fibre composite material requires access to suitable raw material and a specialized manufacturing facility.

A further type of antenna mast having a closed structure comprises a tower made from concrete. WO 2007/108731 discloses a hollow antenna tower structure. The tower comprises a number of concrete sections. Manufacturing such concrete sections requires a dedicated facility for casting the concrete sections. Erecting such a tower will require a heavy crane strong enough and high enough to lift the concrete sections the length of the tower.

Thus, there exists a need for an antenna mast which is adapted for local production and which may be easily erected.

### SUMMARY

An object is to provide an antenna mast for a wireless communication system of simple construction adapted for local production.

According to an aspect, the object is achieved by an antenna mast for supporting at least one antenna of a wireless communication system. The antenna mast comprising: a base section having a closed structure with a bottom end and an upper end, and a first elongated section having a closed structure. The base section has a wider first cross section at the bottom end than a second cross section at the upper end. The base section comprises a substantially horizontal top end. The base section comprises an outer shell assembled from sheet metal steel plates. The first elongated section comprises an outer shell assembled from sheet metal steel plates in the form of an open-ended cylinder. The first elongated section is attached to the top end of the base section with an open inner connection between the base section and the first elongated section.

Since the outer shells of the base section and of the first elongated section are manufactured from sheet metal steel plates, the material forming a main constructional element of the antenna mast is readily available in most areas of the world. Furthermore, due to the outer shell of the antenna mast being assembled from sheet metal steel plates, the manufacturing of the base section and the first elongated section may be performed by metal workers. The antenna mast is of reasonably low weight and may be easily erected due to is division into the base section and the first elongated section. Thus, the antenna mast is of a simplified construction adapted for local production. As a result, the above mentioned object is achieved.

The outer shell of the base section and the outer shell of the first elongated section form the main constructional elements of the base section and the first elongated section. As the main constructional elements the shells encloses the antenna mast and take part in supporting the antenna mast in an erected position. The sheet metal steel plates of the base section may be thicker than the sheet metal steel plates of the first elongated section. The sheet metal steel plates of the base section may be assembled by welding, bolting, riveting, gluing, etc., so may the sheet metal steel plates of the first elongated section. The base section and the first elongated section may be bolted together. A sealing material may be applied in a joint between the base section and the first elongated section. The antenna mast may support one or more antennas at its top. The antennas may be of one type or of different types. Since the base section and the first elongated section have closed structures the antenna mast may house equipment of the wireless communication system. The base section of the antenna mast may be provided with a door to provide access for personnel into the antenna mast. In the base section equipment of the wireless communication system may be arranged, e.g. a base station, a power supply unit, etc. The antenna mast may be internally climbable such that personnel may reach an antenna at a top of the antenna mast. A ladder may be arranged for this purpose in the antenna mast.

According to embodiments the first elongated section may have a polygonal cross section to form a polygonal cylinder. A first elongated section having a polygonal cross section may easily be assembled from sheet metal steel plates.

According to embodiments the base section may comprise base section outer surfaces and the first elongated section may comprise first elongated section outer surfaces. Each base section outer surface may be flat and each first elongated section outer surface may be flat. That is, the outer shell of the base section may comprise the base section outer surfaces and the outer shell of the first elongated section may comprise the first elongated section outer surfaces

According to embodiments the first elongated section may comprise at least three side parts. Each side part may comprise one of the said sheet metal steel plates. The sheet metal steel plate may have one of the said first elongated section outer surfaces facing an ambient environment of the antenna mast and may have an inner surface.

According to embodiments at least one profile may be attached to each sheet metal steel plate of the first elongated section, on the inner surface. The at least one profile may extend in a longitudinal direction of the first elongated section. In this manner it may be ensured that the first elongated section is sufficiently stiff to withstand forces an antenna mast is subjected to. Due to the at least one profile, each sheet metal steel plate of the first elongated section may have a thinner thickness than if no profile would reinforce the sheet metal steel plate.

According to embodiments the antenna mast may comprise a second elongated section substantially identical in shape and structure to the first elongated section. The second elongated section may be attached to the first elongated section. In this manner a modular antenna mast may be provided. Accordingly, an antenna mast may be adapted in height to requirements at a particular site. The sheet metal steel plates of the second elongated section may be thinner than those of the first elongated section.

According to embodiments the antenna mast may comprise a top section. The top section may comprise at least three poles extending between a first member and a second member. The at least three poles may be arranged for mounting of antennas to the antenna mast.

According to embodiments the antenna mast may comprise a foundation. The foundation may comprise at least three concrete elements each comprising an elongated body with a first end and a second end. The elongated body may comprise concrete and reinforcement bars and may be provided with a first end surface. At least one reinforcement bar may extend from the elongated body at the first end. An attachment arrangement may be attached to the elongated body and may extend from the first end surface. The at least three concrete elements may be arranged to extend substantially symmetrically from a central portion of the foundation. Each of the first ends of the at least three concrete elements may be arranged at the central portion of the foundation. The at least one reinforcement bar extending from the elongated bodies of the at least three concrete elements may be joined by a central concrete portion. The base section may be attached to the attachment arrangement of each of the at least three concrete elements. In this manner the antenna mast may be anchored to the ground utilizing a foundation, which is easily manufactured, e.g. compared with a concrete slap foundation.

According to a further aspect, the object is achieved by a method of producing an antenna mast for a wireless communication system, comprising:

assembling an outer shell of a base section having a closed structure with a bottom end and an upper end from sheet metal steel plates, wherein the base section has a wider first cross section at the bottom end than a second cross section at the upper end, the base section comprising a substantially horizontal top end and only substantially flat outer surfaces,

assembling an outer shell of a first elongated section having a closed structure from sheet metal steel plates to form an open-ended cylinder and comprising only substantially flat outer surfaces, and

attaching the first elongated section to the base section at the top end of the base section.

For the reasons mentioned above in connection with the antenna mast the above mentioned object is achieved by the method.

Further features of, and advantages will become apparent when studying the appended claims and the following detailed description. Those skilled in the art will realize that different features may be combined to create embodiments other than those described in the following, without departing from the scope, as defined by the appended claims.

### BRIEF DESCRIPTION OF THE DRAWINGS

The various aspects, including particular features and advantages, will be readily understood from the following detailed description and the accompanying drawings, in which:

FIG. 1 illustrates an antenna mast for supporting at least one antenna of a wireless communication system according to embodiments,

FIG. 2 illustrates a cross section through the base section of FIG. 1,

FIGS. 3a and 3b illustrate two views of a side element of a base section of an antenna mast of a wireless communication system according to embodiments,

FIG. 4 illustrates three side parts adapted to from a first elongated section or second elongated section of an antenna mast according to embodiments,

FIG. 5 illustrates a portion of an antenna mast according to embodiments comprising a first elongated section and a second elongated section,

FIG. 6 illustrates example embodiments of cross sections of profiles for enforcing sheet metal steel plates of an antenna mast,

FIG. 7 illustrates a top section of an antenna mast according to embodiments,

FIG. 8 illustrates a foundation for an antenna mast according to embodiments, and

FIG. 9 illustrates a method of producing an antenna mast for a wireless communication system according to embodiments.

### DETAILED DESCRIPTION

Embodiments will now be described more fully with reference to the accompanying drawings, in which example embodiments are shown. Disclosed features of example embodiments may be combined as readily understood by one of ordinary skill in the art. Like numbers refer to like elements throughout. Well-known functions or constructions will not necessarily be described in detail for brevity and/or clarity.

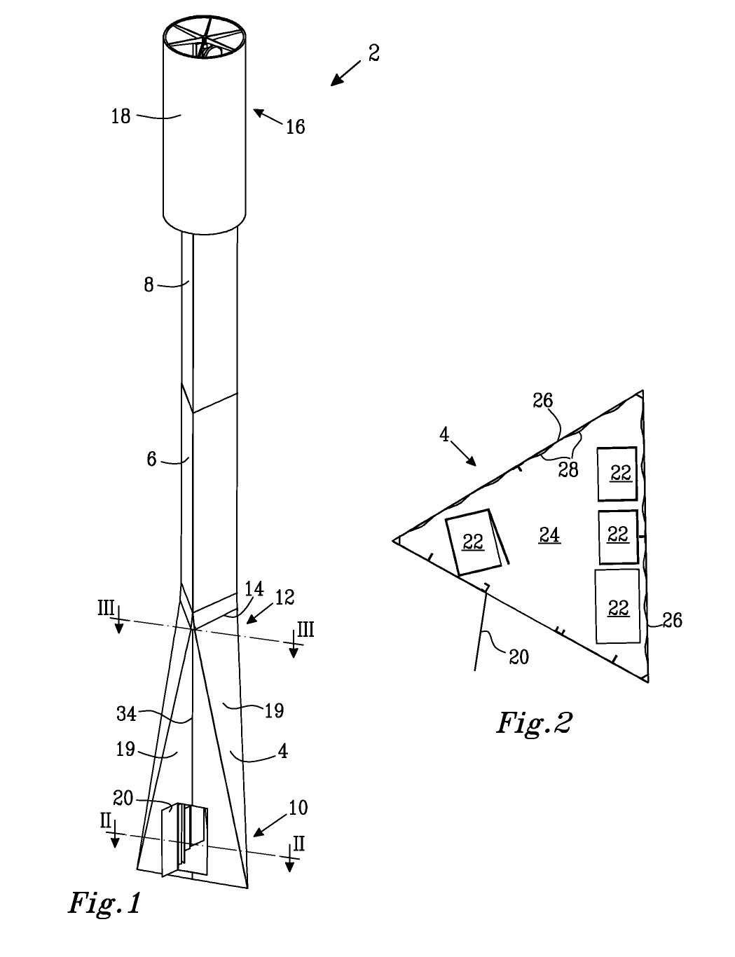

FIG. 1 illustrates an antenna mast 2 for supporting at least one antenna of a wireless communication system according to embodiments. The antenna mast 2 comprises a base section 4 having a closed structure, a first elongated section 6 having a closed structure, and a second elongated section 8 having a closed structure. The base section 4 comprises a bottom end 10 and an upper end 12 and has a wider first cross section II-II at the bottom end 10 than a second cross section III-III at the upper end 12. The first elongated section 6 has the form of an open-ended cylinder. Also the second elongated section 8 has the form of an open-ended cylinder. The base section 4, the first elongated section 6, and the second elongated section 8 each have a polygonal cross section.

The base section 4 comprises a substantially horizontal top end 14. The first elongated section 6 is attached to the top end 14 of the base section 4 with an open inner connection between the base section 4 and the first elongated section 6. The second elongated section 8 is attached to an upper end of the first elongated section 6 with an open inner connection. At an upper end of the second elongated section 8 a top section 16 is attached. The top section 16 is arranged to carry antennas of the antenna mast 2. A radome 18 may cover the top section 16. Thanks to the open inner connection between the different parts of the antenna mast 2, personnel may access the top section 16 and the antennas via an inside of the antenna mast 2. The inside may be provided with a ladder for this purpose.

The base section 4 comprises a number of base section outer surfaces 19. Each base section outer surface 19 is flat. The base section 4 is provided with a door 20 providing access to an interior of the antenna mast 2. In the base section 4, equipment of the wireless communication system is placed.

The base section 4 may have a height of 5-12 m, each elongated section 6, 8 may have a height of 5-12 m, the top section 16 may have a height of 2-7 m. The antenna mast may have a total height of 12-35 m. Inside the base section 6 there may be provided a second floor, e.g. at approximately 2.5 meters above a bottom floor of the base section 6, to form a second level inside the base section 6. The first cross section II-II and the second cross section III-III of the base section 6 may both be triangular cross sections. The two triangular cross sections being displaced 120 degrees in relation to each other such that corners of one triangular cross section are arranged at long sides of the other triangular cross section, and vice versa. Also the first elongated section 6, and/or the second elongated section 8, and/or any higher placed elongated section may be provided internally with one or more floors to form one or more levels inside the elongated sections.

FIG. 2 illustrates a cross section II-II through the base section 4 of FIG. 1. The cross section II-II is taken at the bottom end of the base section 4. Equipment 22 of the wireless communication system is arranged on a floor 24 of the base section 4. The equipment 22 may e.g. comprise a power supply unit, batteries, a base station transceiver, racks for mounting of further gear, etc. Access to the equipment 22 and the interior of the antenna mast is provided via the door 20. The cross section II-II is triangular and may have a side length of 2-4 m. In addition to, or alternatively, equipment of the wireless communication system may be arranged at other places inside the antenna mast than on the floor 24, e.g. on a second floor of the base section mentioned above, in one of the elongated sections, or in the top section.

The base section 4 comprises an outer shell which forms the closed structure and is assembled from sheet metal steel plates 26. The sheet metal steel plates 26 form flat portions and may be e.g. 6 mm thick. The sheet metal steel plates 26 form base section outer surfaces. Reinforcing profiles 28 may be attached to an inner side of the sheet metal steel plates 26. In this manner a stiff outer shell may be achieved at comparatively low weight and comparatively low amount of material required, which outer shell is strong enough to stand forces that the base section 4 is subjected to.

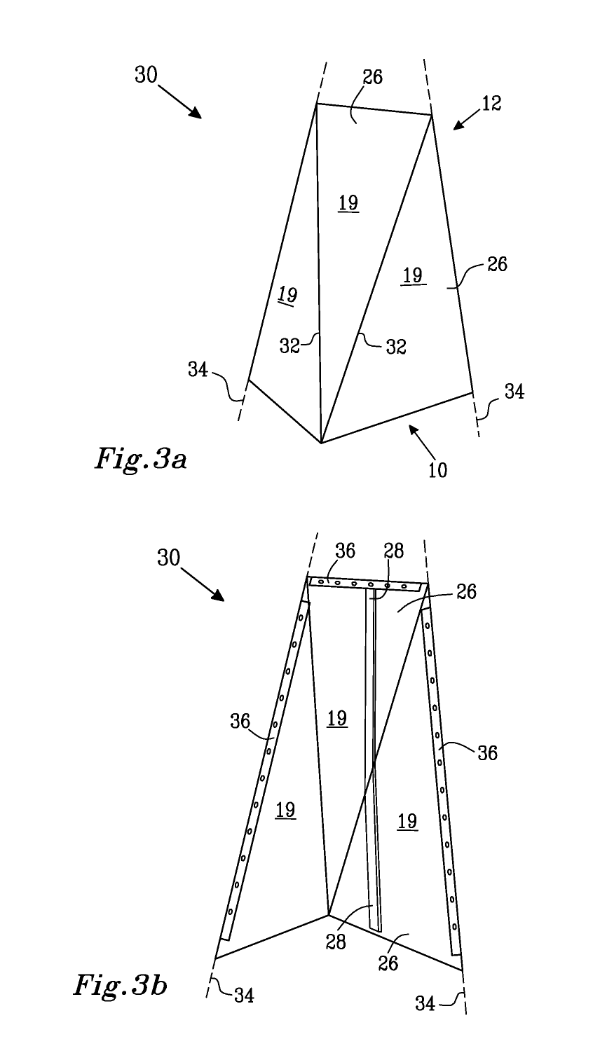

FIGS. 3a and 3b illustrate two views of a side element 30 of a base section of an antenna mast of a wireless communication system according to embodiments. The view of FIG. 3a shows an outer side of the side element 30 and the view of FIG. 3b shows an inner side of the side element 30. The side element 30 comprises flat base section outer surfaces 19. Each base section outer surface 19 extends from a bottom end 10 to an upper end 12 of the base section, i.e. also from a bottom end to an upper end of the side element 30.

The base section may comprise at least three side elements 30, each side element 30 comprising three flat portions attached to each other at two corner portions 32. The side elements 30 may be attached to each other along lines 34 extending along base section outer surfaces 19 from the bottom end 10 to the upper end 12. (One line 34 is indicated also in FIG. 1) The flat portions may be formed by sheet metal steel plates 26 which are welded together at the corner portions 32.

Accordingly, three side elements 30 of the kind illustrated in FIGS. 3a and 3b are assembled to form a base section. Each of the three flat portions is formed from a sheet metal steel plate 26. The three flat portions are triangular and the two corner portions 32 converge from the upper end 12 to the bottom end 10. The lines 34 extending along the base section outer surfaces are substantially vertical. Each of the lines 34 is to extend substantially vertically. A line 34 is be understood as being substantially vertical if it is substantially vertical seen from at least one direction, i.e. a line running substantially vertically along a slanted surface is considered substantially vertical.

The sheet metal steel plates 26 forming the flat portions are provided with a flange 36 each, as illustrated in FIG. 3b. The flanges 36 are provided with through holes, allowing the side element 30 to be attached to other parts of the antenna mast using bolts and nuts. The two flanges 36 extending along the lines 34 are adapted to be attached to one other side element 30 each. The flange 36 at the upper end 12 is adapted to be attached e.g. to a first elongated section of the antenna mast. As an alternative to bolting, the flanges 36 may be fastened together with other parts of the antenna mast using other methods, such as welding or gluing.

Reinforcing profiles 28 are attached to an inner side of the sheet metal steel plates 26. In FIG. 3b two such profiles 28 are schematically illustrated. The illustrated profiles 28 meet at a corner portion between the sheet metal steel plates. Alternatively, one profile may extend over the corner portion. In practice, more reinforcing profiles 28 than illustrated in FIG. 3b may be attached to the inner sides of the sheet metal steel plates 26.

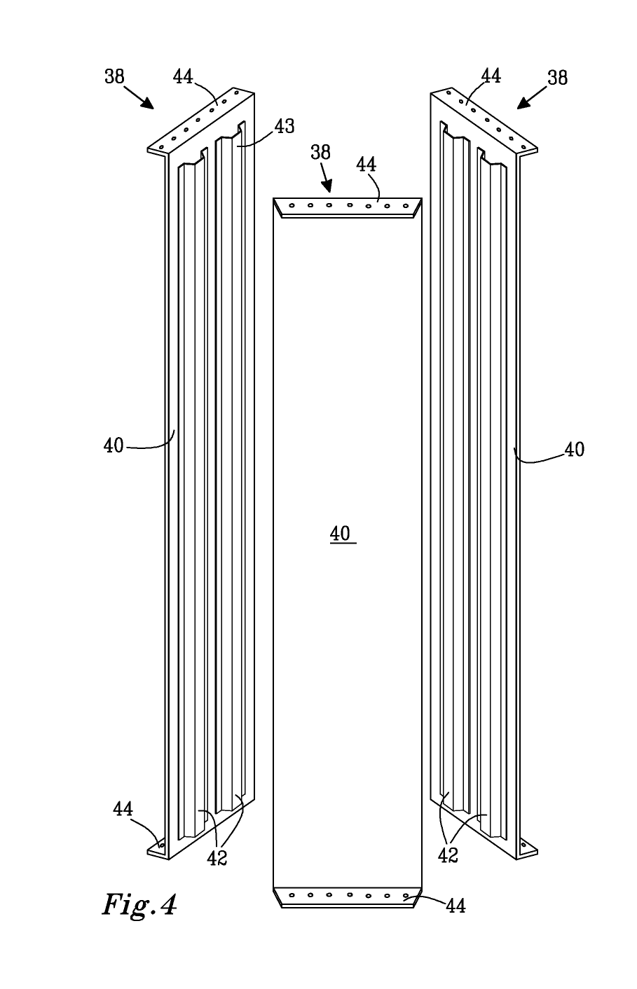

FIG. 4 illustrates three side parts 38 adapted to from a first elongated section or second elongated section of an antenna mast according to embodiments. Each side part comprises a sheet metal steel plate 40. The sheet metal steel plate 40 has an elongated section outer surface, which outer surface faces an ambient environment of the antenna mast. The sheet metal steel plate 40 has an inner surface. Two profiles 42 are attached to the sheet metal steel plate 40 on the inner surface. The two profiles 42 extend in a longitudinal direction of the elongated section. Each profile 42 comprises a profile portion 43, which profile portion 43 extends at a distance from the inner surface substantially in a plane parallel with the inner surface. Only one or more than two profiles 42 may be attached to each sheet metal steel plate 40.

Thanks to the profiles 42 comparatively thin sheet metal steel plates 40 may be used in the elongated section. As an example a sheet metal steel plates 40 of a first elongate section, reinforced as illustrated by profiles 40, may have a thickness of 4 mm and a sheet metal steel plates 40 of a second elongated section, reinforced by profiles 42, may have a thickness of 3 mm.

The sheet metal steel plates 40 may be welded together along their long sides to form an elongated section having a triangular cross section. Alternatively, the sheet metal steel plates 40 may be bolted together or attached to each other by other suitable methods. At their short ends the sheet metal steel plates 40 are provided with flanges 44 for attaching the elongated section to other parts of the antenna mast.

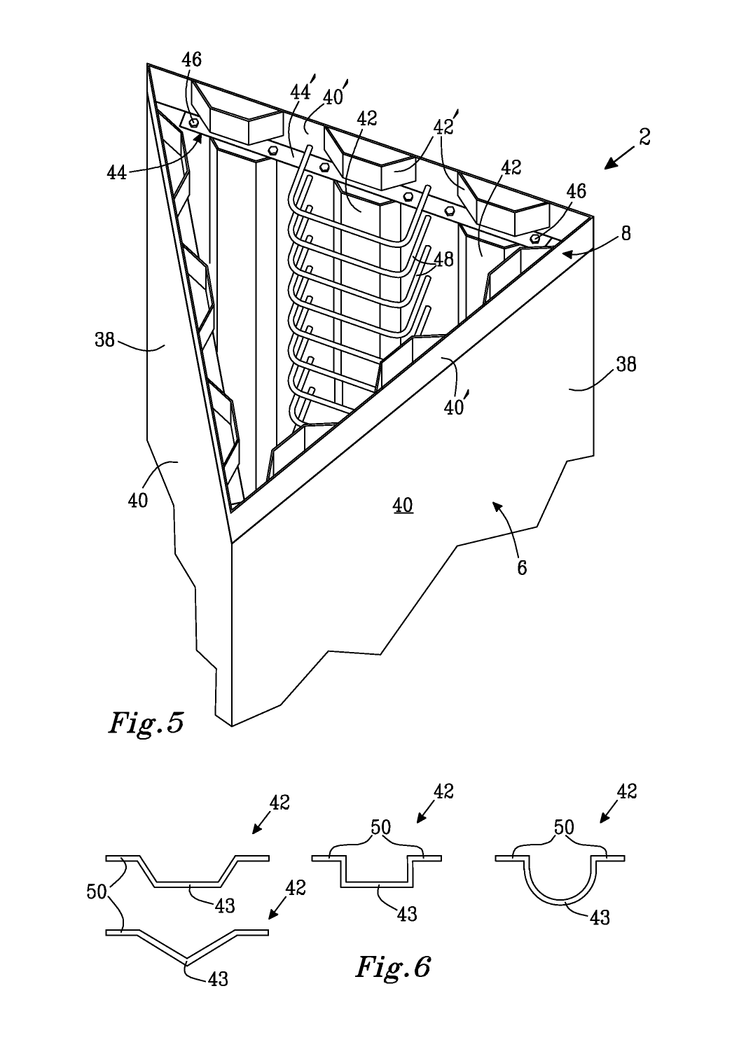

FIG. 5 illustrates a portion of an antenna mast 2 according to embodiments comprising a first elongated section 6 and a second elongated section 8. The first elongated section 6 comprises an outer shell which forms a closed structure and is assembled from sheet metal steel plates 40. The first elongated section 6 has a polygonal cross section to form a polygonal open-ended cylinder. The first elongated section has a triangular cross section. The triangular cross section may have a side length of 1-3 m. The first elongated section 6 comprises side elements 38 having first elongated section outer surfaces. Each first elongated section outer surface is flat. Each side element 38 is reinforced with profiles 42 arranged on an inner side of each sheet metal steel plate 40. The second elongated section 8 is built up in a similar manner as the first elongated section 6 comprising sheet metal steel plates 40′ and reinforcing profiles 42′. The first and second elongated sections 6, 8 are each provided with flanges 44, 44′ at their ends. The first and second elongated sections 6, 8 are attached to each other by means of bolts 46 extending through the flanges 44, 44′. Steps 48 forming a ladder inside the antenna mast 2 are attached to an inside of the first and second elongated sections 6, 8.

FIG. 6 illustrates example embodiments of cross sections of profiles for enforcing sheet metal steel plates of an antenna mast. Each of the profiles 42 may be used for enforcing sheet metal steel plates of a base section as well as for enforcing sheet metal steel plates of first and second elongated sections. A profile 42 may alternatively be referred to as structural steel member. Each of the profiles 42 has a cross section with at least one portion 50 adapted to be attached to a sheet metal steel plate, i.e. a substantially flat portion 50. A profile may be attached to a sheet metal steel plate e.g. by gluing, welding, riveting or bolting. Each profile 42 comprises a profile portion 43, which profile portion 43 is adapted to extend at a distance from and in a plane parallel with the sheet metal steel plate the profile 42 is adapted to support. A profile 42 may have a material thickness of 2-5 mm, a width of the profile 42 may be 150-400 mm and a distance between the at least one portion 50 and the profile portion 43 may be 30-120 mm.

Also profiles with other cross sections may be used for reinforcing the sheet metal steel plates of an antenna mast, e.g. standard profiles such as I-beam, U-beam, H-beam, etc.

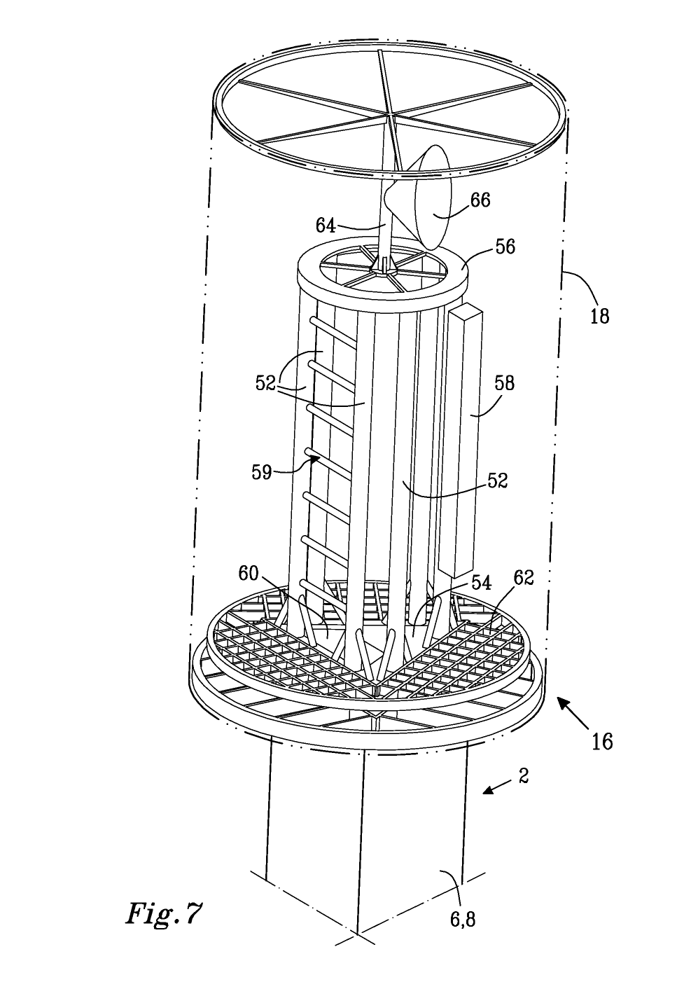

FIG. 7 illustrates a top section 16 of an antenna mast 2 according to embodiments. The top section 16 is attached at an upper end of a topmost elongated section of the antenna mast 2. The elongated section may be a second elongated section 8 of the antenna mast 2. Alternatively, if the antenna mast 2 is of a short kind, which does not comprise a second elongated section, the elongated section may be a first elongated section 6 of the antenna mast 2. The top section 16 comprises at least three poles 52, in this case six poles 52, extending between a first member 54 and a second member 56 of the top section 16. The at least three poles 52 are arranged for mounting of antennas 58 to the antenna mast 2. A ladder 59 may be arranged between two of the poles 52.

A door 60 is provided between the elongated section and the top section 16. The top section 16 comprises a working platform 62 arranged for personnel to stand on. A shaft 64 is provided at an upper end of the top section 16. The shaft 64 may be arranged for mounting of further antennas 66 to the antenna mast 2. A radome 18 covers the top section 16. The radome is permeable to radio waves and may comprise for instance, a fabric or fibre glass.

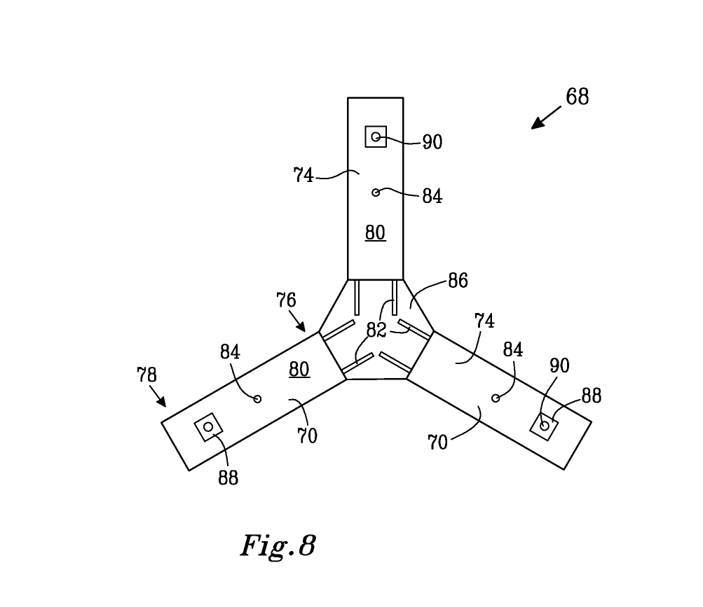

FIG. 8 illustrates a foundation 68 for an antenna mast according to embodiments. The foundation 68 is illustrated in a view seen from above. The foundation 68 comprises three concrete elements 70. Each concrete element 70 comprises an elongated body 74 with a first end 76 and a second end 78. The elongated body 74 comprises concrete and reinforcement bars and is provided with a first end surface 80. At least one reinforcement bar 82 extends from the elongated body 74 at the first end 76. An attachment arrangement 84 is attached to the elongated body 74 and extends from the first end surface 80. The three concrete elements 70 extend substantially symmetrically from a central portion of the foundation 68. Each of the first ends 76 of the three concrete elements 70 are arranged at the central portion of the foundation 68. The reinforcement bars 82 extending from the elongated bodies 74 of the at least three concrete elements 70 are joined by a central concrete portion 86. The reinforcement bars 82 extending from the elongated bodies 74 at the first ends 76 are illustrated for the sake of clarity in FIG. 8 although they in practice are cast in the central concrete portion 86.

The elongated body 74 of each of the three concrete elements 70 is provided with a through hole 88 extending through the first end surface 80. A pile 90 extends through each through hole 88 of the three concrete elements 70 into the ground and each pile 90 is secured in each through hole 88 by a concrete filling. Alternatively, one or more of the concrete elements 70 may be secured to the ground by other means than a pile, e.g. by anchoring to bedrock, if bedrock is present in the ground.

Such a foundation 68 requires less concrete and is more easily produced than an ordinary slab foundation.

When building the foundation 68, the concrete elements 70 are placed in a pit in the ground, symmetrical arranged as discussed above. The central concrete portion 86 is cast. Soil is filled up against the concrete elements 70. The piles 90 are driven into the ground and the concrete filling is cast in the through hole 88. At least some of these steps may be performed in a different order.

A base section of an antenna mast is attached to the attachment arrangement 84 of each of the at least three concrete elements 70 and is thus, safely anchored to the ground. The attachment arrangement 84 may comprises at least one threaded shaft and at least one nut.

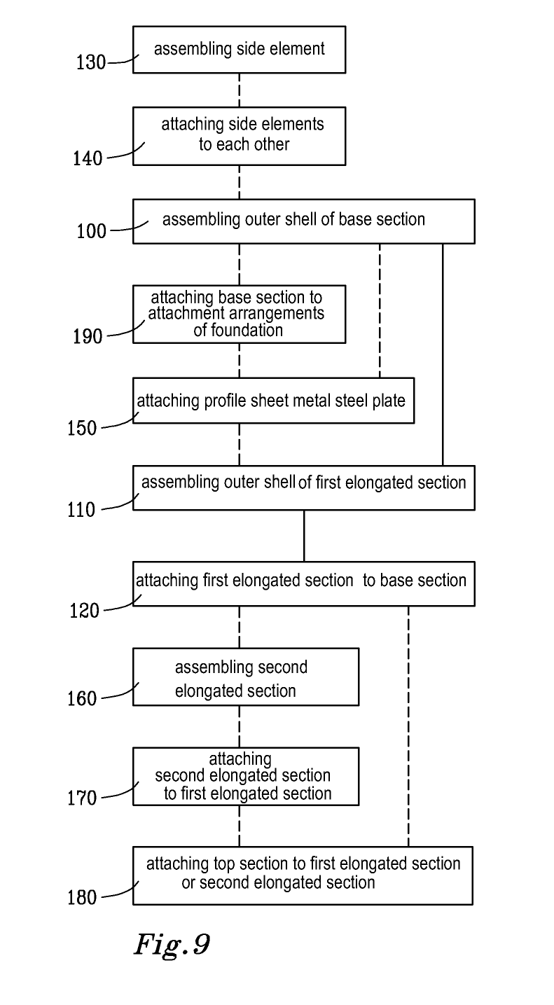

FIG. 9 illustrates a method of producing an antenna mast for a wireless communication system according to embodiments. The method comprises:

assembling 100 an outer shell of a base section having a closed structure with a bottom end and an upper end from sheet metal steel plates, wherein the base section has a wider first cross section at the bottom end than a second cross section at the upper end, the base section comprising a substantially horizontal top end and only substantially flat outer surfaces,

assembling 110 an outer shell of a first elongated section having a closed structure from sheet metal steel plates to form an open-ended cylinder and comprising only substantially flat outer surfaces, and

attaching 120 the first elongated section to the base section at the top end of the base section.

According to embodiments the base section may comprise at least three side elements. The method may further comprise:

assembling 130 each side element from three flat portions by attaching the three portions to each other at two corner portions, and

attaching 140 the side elements to each other along lines extending along the base section outer surfaces from the bottom end to the upper end of the base section.

According to embodiments the first elongated section may comprise at least three side parts. Each side part may comprise one of the said sheet metal steel plates, the sheet metal steel plate having a first elongated section outer surface adapted to face an ambient environment of the antenna mast and having an inner surface. The method may further comprise:

attaching 150 at least one profile to the sheet metal steel plate on the inner surface to extend in a longitudinal direction of the first elongated section.

According to embodiments the method may comprise:

assembling 160 a second elongated section with a closed structure from sheet metal steel plates to form an open-ended cylinder and comprising only substantially flat outer surfaces, and

attaching 170 the second elongated section to the first elongated section.

According to embodiments the method may comprise:

attaching 180 a top section to a topmost elongated section, the top section comprising at least three elongated poles extending between a first member and a second member.

According to embodiments the method may comprise:

attaching 190 the base section to an attachment arrangements of a foundation. The foundation may comprise at least three concrete elements each comprising an elongated body with a first end and a second end. The elongated body may comprise concrete and reinforcement bars and may be provided with a first end surface. At least one reinforcement bar may extend from the elongated body at the first end. The attachment arrangement may be attached to the elongated body and may extend from the first end surface. The at least three concrete elements may be arranged to extend substantially symmetrically from a central portion of the foundation. Each of the first ends of the at least three concrete elements may be arranged at the central portion of the foundation. The at least one reinforcement bar of the at least three concrete elements may be joined by a central concrete portion.

Attaching 190 the base section to the attachment arrangement of the foundation may be performed at any suitable point in the method after assembling 100 the outer shell of the base section, e.g. directly after the assembling 100, after attaching 120 the first elongated section to the base section, or after attaching 180 the top section, etc. Example embodiments described above may be combined as understood by a person skilled in the art. It is also understood by those skilled in the art that an antenna mast may comprise more than two elongated sections. Any further elongated section may be substantially identical in shape and structure to the first elongated section. The thickness of the sheet metal steel plates may differ between elongated sections at different levels of an antenna mast.

Although reference has been made to example embodiments, many different alterations, modifications and the like will become apparent for those skilled in the art. For instance may a sealant be applied between various parts of an antenna mast 2, e.g. between a base section 4 and a first elongated section 6, between a first elongated section 6 and a second elongated section, between side elements 30 of a base section, etc.

In the present context, a cylinder is understood to be a cone whose apex is at infinity.

As used herein, the term “comprising” or “comprises” is open-ended, and includes one or more stated features, elements, steps, components or functions but does not preclude the presence or addition of one or more other features, elements, steps, components, functions or groups thereof.

As used herein, the term “and/or” includes any and all combinations of one or more of the associated listed items.

As used herein, the common abbreviation “e.g.”, which derives from the Latin phrase “exempli gratia,” may be used to introduce or specify a general example or examples of a previously mentioned item, and is not intended to be limiting of such item. If used herein, the common abbreviation “i.e.”, which derives from the Latin phrase “id est,” may be used to specify a particular item from a more general recitation.

The terminology used herein is for the purpose of describing particular embodiments only and is not intended to be limiting. As used herein, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that when an element is referred to as being “on”, “coupled”, “attached” or “connected” to another element, it can be directly on, coupled, attached or connected to the other element or intervening elements may also be present. In contrast, when an element is referred to as being “directly on”, “directly coupled”, “directly attached” or “directly connected” to another element, there are no intervening elements present.

It will be understood that although the terms first, second, third etc. may be used herein to describe various elements, components, and/or sections, these elements, components, and/or sections should not be limited by these terms. These terms are only used top distinguish one element, component, or section from another element, component, or section. Thus, a first element, component, or section discussed herein could be termed a second element, component, or section without departing from the teachings herein.

1-21. (canceled)

22. An antenna mast for supporting at least one antenna of a wireless communication system, the antenna mast comprising:
a base section comprising an outer shell assembled from sheet metal steel plates and having a closed structure with a bottom end and a upper end, wherein the base section has a wider first cross section at the bottom end than a second cross section at the upper end, and wherein the base section comprises a substantially horizontal top end; and
a first elongated section having a closed structure and comprising an outer shell assembled from sheet metal steel plates in the form of an open-ended cylinder;
wherein the first elongated section is attached to the top end of the base section with an open inner connection between the base section and the first elongated section.

23. The antenna mast according to claim 22, wherein the first elongated section has a polygonal cross section to form a polygonal cylinder.

24. The antenna mast according to claim 22, wherein the base section comprises base section outer surfaces and the first elongated section comprises first elongated section outer surfaces, and wherein each base section outer surface is flat and each first elongated section outer surface is flat.

25. The antenna mast according to claim 24, wherein each base section outer surface extends from the bottom end to the upper end of the base section.

26. The antenna mast according to claim 24, wherein the base section comprises at least three side elements, each side element comprising three flat portions attached to each other at two corner portions, and wherein the side elements are attached to each other along lines extending along the base section outer surfaces from the bottom end to the upper end.

27. The antenna mast according to claim 26, wherein the three flat portions are triangular and the two corner portions converge from the upper end to the bottom end, and wherein the lines extending along the base section outer surfaces are substantially vertical.

28. The antenna mast according to claim 24, wherein the first elongated section comprises at least three side parts, each side part comprising one of said sheet metal steel plates, the sheet metal steel plate having one of said first elongated section outer surfaces facing an ambient environment of the antenna mast and having an inner surface.

29. The antenna mast according to claim 28, wherein at least one profile is attached to the sheet metal steel plate on the inner surface, and wherein the at least one profile extends in a longitudinal direction of the first elongated section.

30. The antenna mast according to claim 29, wherein the at least one profile comprises a profile portion, which profile portion extends at a distance from the inner surface substantially in a plane parallel with the inner surface.

31. The antenna mast according to claim 22, wherein the first elongated section has a triangular cross section.

32. The antenna mast according to claim 22, wherein the antenna mast comprises a second elongated section substantially identical in shape and structure to the first elongated section, and wherein the second elongated section is attached to the first elongated section.

33. The antenna mast according to claim 22, wherein the antenna mast comprises a top section, the top section comprising at least three poles extending between a first member and a second member, the at least three poles being arranged for mounting of antennas to the antenna mast.

34. The antenna mast according to claim 33, wherein a radome covers the top section.

35. The antenna mast according to claim 22, wherein the antenna mast comprises a foundation, the foundation comprising at least three concrete elements each comprising an elongated body with a first end and a second end, the elongated body comprising concrete and reinforcement bars and being provided with a first end surface, and wherein at least one reinforcement bar extends from the elongated body at the first end and an attachment arrangement is attached to the elongated body and extends from the first end surface, which at least three concrete elements are arranged to extend substantially symmetrically from a central portion of the foundation, wherein each of the first ends of the at least three concrete elements are arranged at the central portion of the foundation, and wherein the at least one reinforcement bar extending from the elongated bodies of the at least three concrete elements are joined by a central concrete portion, the base section being attached to the attachment arrangement of each of the at least three concrete elements.

36. The antenna mast according to claim 35, wherein the elongated body of each of the at least three concrete elements is provided with a through hole extending through the first end surface, and wherein a pile extends through each through hole of the at least three concrete elements and each pile is secured in each through hole by a concrete filling.

37. A method of producing an antenna mast for a wireless communication system, the method comprising:
assembling an outer shell of a base section having a closed structure with a bottom end and an upper end from sheet metal steel plates, wherein the base section has a wider first cross section at the bottom end than a second cross section at the upper end, the base section comprising a substantially horizontal top end and only substantially flat outer surfaces,
assembling an outer shell of a first elongated section having a closed structure from sheet metal steel plates to form an open-ended cylinder and comprising only substantially flat outer surfaces, and
attaching the first elongated section to the base section at the top end of the base section.

38. The method according to claim 37, wherein the base section comprises at least three side elements, the method further comprising:
assembling each side element from three flat portions by attaching the three portions to each other at two corner portions, and
attaching the side elements to each other along lines extending along the base section outer surfaces from the bottom end to the upper end of the base section.

39. The method according to claim 37, wherein the first elongated section comprises at least three side parts, each side part comprising one of said sheet metal steel plates, the sheet metal steel plate having a first elongated section outer surface adapted to face an ambient environment of the antenna mast and having an inner surface, the method further comprising attaching at least one profile to the sheet metal steel plate on the inner surface to extend in a longitudinal direction of the first elongated section.

40. The method according to claim 37, further comprising:
assembling a second elongated section with a closed structure from sheet metal steel plates to form an open-ended cylinder comprising only substantially flat outer surfaces, and
attaching the second elongated section to the first elongated section.

41. The method according to claim 37, further comprising attaching a top section to a topmost elongated section, the top section comprising at least three elongated poles extending between a first member and a second member.

42. The method according to claim 37, further comprising attaching the base section to an attachment arrangement of a foundation, the foundation comprising at least three concrete elements each comprising an elongated body with a first end and a second end, the elongated body comprising concrete and reinforcement bars and being provided with a first end surface, wherein at least one reinforcement bar extends from the elongated body at the first end and the attachment arrangement is attached to the elongated body and extends from the first end surface, which at least three concrete elements are arranged to extend substantially symmetrically from a central portion of the foundation, wherein each of the first ends of the at least three concrete elements are arranged at the central portion of the foundation, and wherein the at least one reinforcement bar of the at least three concrete elements are joined by a central concrete portion.
